(19) United States
(12) Patent Application Publication
(10) Pub. No.: US 2026/0299258 A1
(43) Pub. Date: Oct. 1, 2026

(54) IMAGING LENS, IMAGE CAPTURING UNIT AND ELECTRONIC DEVICE

(71) Applicant: LARGAN PRECISION CO., LTD., Taichung City (TW)

(72) Inventors: Chih-Wen HSU, Taichung City (TW); Yu Chen LAI, Taichung City (TW)

(73) Assignee: LARGAN PRECISION CO., LTD., Taichung City (TW)

(21) Appl. No.: 19/541,575

(22) Filed: Feb. 17, 2026

Related U.S. Application Data
(60) Provisional application No. 63/779,625, filed on Mar. 28, 2025.

(51) Int. Cl. G02B 13/00; G02B 9/62

(52) U.S. Cl. CPC G02B 13/0045; G02B 9/62; G02B 13/0015

(57) ABSTRACT

An imaging lens includes lens elements arranged along an optical axis, a lens barrel, a first opening element and a second opening element. The lens elements include a first lens element. The lens barrel includes a tube portion surrounding the optical axis, with the lens elements disposed therein and an opening portion extending along a direction from the tube portion towards the optical axis. The opening portion has a barrel opening located on an object side of the first lens element and a first step surface. The first opening element is disposed between the first lens element and the opening portion to space the first lens element apart from the opening portion. The first opening element and the first step surface form a gap therebetween in which the second opening element is disposed. The first and second opening elements each have a light-passable opening.

### RELATED APPLICATIONS

This application claims priority to U.S. Provisional Application 63/779,625, filed on Mar. 28, 2025, which is incorporated by reference herein in its entirety.

### BACKGROUND

### Technical Field

The present disclosure relates to an imaging lens, an image capturing unit and an electronic device, more particularly to an imaging lens applicable to an image capturing unit and an electronic device.

### Description of Related Art

With the development of technology, featuring high image quality becomes one of the indispensable features of an optical system nowadays. Furthermore, electronic devices equipped with optical systems are trending towards multi-functionality for various applications, and therefore the functionality requirements for the optical systems have been increasing.

However, conventional optical lenses are difficult to meet the requirements of high optical quality of an electronic device under diversified development in recent years, particularly in terms of high requirements for low-glare imaging performance in the market of the current technology trends. Therefore, how to improve the mechanism in an optical lens to meet the stringent requirements of high-end-specification electronic devices is an important topic in this field nowadays.

### SUMMARY

According to one aspect of the present disclosure, an imaging lens includes a plurality of lens elements, a lens barrel, a first opening element and a second opening element. The plurality of lens elements are arranged along an optical axis. The plurality of lens elements include a first lens element as being one of the plurality of lens elements closest to an object side of the imaging lens. The lens barrel includes a tube portion and an opening portion. The tube portion surrounds the optical axis. The plurality of lens elements are disposed in the tube portion. The opening portion extends along a direction from the tube portion towards the optical axis. The opening portion has a barrel opening and a first step surface. The barrel opening is located on an object side of the first lens element. The first opening element is disposed between the first lens element and the opening portion to space the first lens element apart from the opening portion. The first opening element and the first step surface form a gap therebetween. The first opening element has a first light-passable opening disposed corresponding to the barrel opening. The second opening element is disposed in the gap. The second opening element has a second light-passable opening disposed opposite to the first light-passable opening.

According to another aspect of the present disclosure, an imaging lens includes a plurality of lens elements, a lens barrel, a first opening element and a second opening element. The plurality of lens elements are arranged along an optical axis. The plurality of lens elements include a first lens element. The lens barrel includes a tube portion and an opening portion. The tube portion surrounds the optical axis. The plurality of lens elements are disposed in the tube portion. The opening portion extends along a direction from the tube portion towards the optical axis. The opening portion has a barrel opening and a first step surface. The first lens element abuts on a side of the first opening element away from the opening portion. The first opening element and the first step surface form a gap therebetween. The first opening element has a first light-passable opening disposed corresponding to the barrel opening. The second opening element is disposed in the gap. The second opening element has a second light-passable opening disposed opposite to the first light-passable opening.

According to another aspect of the present disclosure, an imaging lens includes a plurality of lens elements, a lens barrel, a first opening element and a second opening element. The plurality of lens elements are arranged along an optical axis. The plurality of lens elements include a first lens element. The lens barrel includes a tube portion and a barrel opening element. The tube portion surrounds the optical axis. The plurality of lens elements are disposed in the tube portion. The barrel opening element is fixed on the tube portion. The barrel opening element has an opening portion extending along a direction towards the optical axis. The opening portion has a barrel opening and a first step surface. The first lens element abuts on a side of the first opening element away from the opening portion. The first opening element and the first step surface form a gap therebetween. The first opening element has a first light-passable opening disposed corresponding to the barrel opening. The second opening element is disposed in the gap. The second opening element has a second light-passable opening disposed opposite to the first light-passable opening.

According to another aspect of the present disclosure, an image capturing unit includes one of the aforementioned imaging lenses.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a perspective view of an imaging lens according to the 1st embodiment of the present disclosure;

FIG. 2 is an exploded view of the imaging lens in FIG. 1;

FIG. 3 is a perspective view of the imaging lens in FIG. 1 that has been sectioned;

FIG. 4 is a cross-sectional view of the imaging lens in FIG. 1;

FIG. 5 is an enlarged view of AA region of the imaging lens in FIG. 4;

FIG. 6 is an enlarged view of BB region of the imaging lens in FIG. 5;

FIG. 7 is another schematic view of the imaging lens in FIG. 5;

FIG. 8 is further another schematic view of the imaging lens in FIG. 5;

FIG. 9 is a perspective view of an imaging lens according to the 2nd embodiment of the present disclosure;

FIG. 10 is an exploded view of the imaging lens in FIG. 9;

FIG. 11 is a perspective view of the imaging lens in FIG. 9 that has been sectioned;

FIG. 12 is a cross-sectional view of the imaging lens in FIG. 9;

FIG. 13 is an enlarged view of CC region of the imaging lens in FIG. 12;

FIG. 14 is an enlarged view of DD region of the imaging lens in FIG. 13;

FIG. 15 is a perspective view of an imaging lens according to the 3rd embodiment of the present disclosure;

FIG. 16 is an exploded view of the imaging lens in FIG. 15;

FIG. 17 is a perspective view of the imaging lens in FIG. 15 that has been sectioned;

FIG. 18 is a cross-sectional view of the imaging lens in FIG. 15;

FIG. 19 is an enlarged view of EE region of the imaging lens in FIG. 18;

FIG. 20 is an enlarged view of FF region of the imaging lens in FIG. 19;

FIG. 21 is a perspective view of an imaging lens according to the 4th embodiment of the present disclosure;

FIG. 22 is an exploded view of the imaging lens in FIG. 21;

FIG. 23 is a perspective view of the imaging lens in FIG. 21 that has been sectioned;

FIG. 24 is a cross-sectional view of the imaging lens in FIG. 21;

FIG. 25 is an enlarged view of GG region of the imaging lens in FIG. 24;

FIG. 26 is an enlarged view of HH region of the imaging lens in FIG. 25;

FIG. 27 is a perspective view of an electronic device according to the 5th embodiment of the present disclosure;

FIG. 28 is a perspective view of an electronic device according to the 6th embodiment of the present disclosure;

FIG. 29 is another perspective view of the electronic device in FIG. 28;

FIG. 30 is an illustration of an image captured by an ultra-wide-angle image capturing unit;

FIG. 31 is an illustration of an image captured by a high pixel image capturing unit;

FIG. 32 is an illustration of an image captured by a telephoto image capturing unit;

FIG. 33 is a perspective view of an electronic device according to the 7th embodiment of the present disclosure;

FIG. 34 is a perspective view of an electronic device according to the 8th embodiment of the present disclosure;

FIG. 35 is a side view of the electronic device in FIG. 34; and

FIG. 36 is a top view of the electronic device in FIG. 34.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an image capturing unit includes an imaging lens and an image sensor assembly. The imaging lens is disposed on an object side of the image sensor assembly. The image sensor assembly includes an image sensor disposed on an image surface of the imaging lens. Moreover, the image sensor assembly may further include other components such as a filter, but the present disclosure is not limited thereto.

The imaging lens includes a plurality of lens elements, a lens barrel, a first opening element and a second opening element.

The lens elements are arranged along an optical axis. The lens elements include a first lens element and at least one remaining lens element. The first lens element may be one of the lens elements closest to an object side of the imaging lens. It can also be considered that the first lens element may be located closer to the object side of the imaging lens than the at least one remaining lens element.

The lens barrel may include a barrel opening element. In specific, the lens barrel may include a tube portion and the barrel opening element fixed on the tube portion, and the barrel opening element may include an opening portion.

The tube portion surrounds the optical axis, and the lens elements are disposed in the tube portion.

The opening portion extends along a direction towards the optical axis. More specific, the opening portion may extend along a direction from the tube portion towards the optical axis. The opening portion may have a barrel opening, a first step surface, a first connection surface and a second step surface.

The barrel opening is located on an object side of the first lens element.

The first step surface may be located closer to the optical axis than the second step surface. The first step surface may be located closer to the barrel opening than the second step surface.

The first connection surface connects the first step surface to the second step surface.

The second step surface may be at least partially overlapped with the first lens element in a direction parallel to the optical axis.

The first opening element is disposed between the first lens element and the opening portion to space the first lens element apart from the opening portion. The first opening element has a side away from the opening portion on which the first lens element abuts, thereby maintaining the distance between the first lens element and the barrel opening. The first opening element and the first step surface form a gap therebetween. The first opening element may have a first light-passable opening, a third step surface, a second connection surface and a fourth step surface.

The first light-passable opening is disposed corresponding to the barrel opening.

The first opening element may be in physical contact with the second step surface of the opening portion. More specific, the third step surface of the first opening element is in physical contact with the second step surface of the opening portion.

The second connection surface extends along a direction from a side of the third step surface close to the optical axis towards the first step surface. The second connection surface is disposed spaced apart from the first connection surface.

The fourth step surface extends along a direction from a side of the second connection surface close to the first step surface towards the optical axis. The fourth step surface and the first step surface form the abovementioned gap therebetween.

The second opening element may be a light-blocking sheet. The second opening element is disposed in the gap. The second opening element may be in contact with the opening portion and the first opening element respectively through the first connection surface and the second connection surface. The second opening element has a second light-passable opening disposed opposite to the first light-passable opening.

With the arrangement of the first opening element, it is favorable for spacing the first lens element apart from the barrel opening while retaining the second opening element in the gap, which can reduce the tolerance between the first opening and the lens elements so as to improve optical image quality of the imaging lens.

Moreover, with the coordinated arrangement between the barrel opening, the first light-passable opening and second light-passable opening, it is favorable for improving light with a relatively large incident angle, thereby preventing glare and improving optical image quality of the imaging lens.

In some embodiments of the present disclosure, with the arrangement of the opening portion on the object side of the first lens element, it is favorable for reducing stray light incident into the imaging lens, thereby further ensuring optical image quality.

In some other embodiments of the present disclosure, with the design of the second step surface, it is favorable for improving the alignment between the light-passable opening and the first lens element, thereby maintaining optical image quality.

In some other embodiments of the present disclosure, with the coordinated arrangement between the first step surface, the second step surface, the third step surface, the first connection surface and the second connection surface, it is favorable for aligning the second light-passable opening and the barrel opening, thereby ensuring optical image quality.

In some other embodiments of the present disclosure, the third step surface, the second connection surface and the fourth step surface can form a step structure, such that the second opening element can be easily retained in the gap, thereby ensuring optical image quality.

The opening portion may further have a first conical surface inclined away from the optical axis along a direction from the barrel opening towards the second opening element.

The first opening element may further have a second conical surface inclined away from the optical axis along a direction from the first light-passable opening towards the second opening element.

At least one of the first conical surface and the second conical surface may include an anti-reflection structure surrounding the optical axis. The anti-reflection structure includes a plurality of protrusions. The protrusions may be sequentially arranged along a direction surrounding the optical axis. The protrusions may be annular to surround the optical axis and may be sequentially arranged along a direction away from the optical axis. With the design of the anti-reflection structure, it is favorable for reducing glare caused by reflection of non-imaging light off the first conical surface or the second conical surface, thereby ensuring optical image quality.

A minimum thickness of the opening portion at the first step surface in a direction parallel to the optical axis may be less than a minimum thickness of the opening portion at the second step surface in a direction parallel to the optical axis. Therefore, it is favorable for preventing deformation during assembly so as to maintain optical image quality.

A shortest distance between the first lens element and the first light-passable opening may be less than a shortest distance between the second opening element and the first light-passable opening. Therefore, it is favorable for reducing the risk of glare caused by light passing through the edge of the first lens element, thereby ensuring optical image quality.

A shortest distance between the first lens element and the first light-passable opening may be less than a shortest distance between the first lens element and the second light-passable opening. Therefore, it is favorable for improving the stray light blocking effect of the first opening element, thereby further ensuring optical image quality.

When a minimum width of the gap between the first step surface and the first opening element in a direction parallel to the optical axis is G, and a shortest distance in a direction parallel to the optical axis between the first step surface and the second step surface is D12, the following condition can be satisfied: 0.06≤G/D12≤0.5. Therefore, it is favorable for maintaining the gap distance and further reducing assembly tolerance. Moreover, the following condition can also be satisfied: 0.08≤G/D12≤0.45. Moreover, the following condition can also be satisfied: 0.1≤G/D12 ≤0.4.

In the case that the second opening element is the light-blocking sheet, when the minimum width of the gap between the first step surface and the first opening element in the direction parallel to the optical axis is G, and a thickness of the light-blocking sheet is T, the following condition can be satisfied: 1.03≤G/T≤1.97. Therefore, it is favorable for preventing the first opening element from squeezing the light-blocking sheet so as to prevent deformation of the light-blocking sheet. Moreover, the following condition can also be satisfied: 1.1≤G/T≤1.92.

Each of the barrel opening, the first light-passable opening and the second light-passable opening has a maximum opening diameter. When the maximum opening diameter of the barrel opening is Dib, the maximum opening diameter of the first light-passable opening is Di1, and the maximum opening diameter of the second light-passable opening is Di2, the following conditions can be satisfied: 0.85≤Dib/Di2≤1.15; and 0.85≤Di1/Di2≤1.15. Therefore, it is favorable for improving optical image quality for light with a relatively large incident angle and also preventing glare. Moreover, the following conditions can also be satisfied: 0.8≤Dib/Di2≤1.2; and 0.8≤Di1/Di2≤1.2. Moreover, the following condition can also be satisfied: 0.9≤Dib/Di2≤1.1; and 0.9≤Di1/Di2≤1.1.

When a minimum thickness of the opening portion at the first step surface in a direction parallel to the optical axis is T1, and a thickness of the first opening element in a direction parallel to the optical axis is TS1, the following condition can be satisfied: 0.14≤T1/TS1≤0.92. Therefore, it is favorable for maintaining the interval between the first lens element and the barrel opening so as to maintain optical image quality. Moreover, the following condition can also be satisfied: 0.2≤T1/TS1≤0.7.

According to the present disclosure, the aforementioned features and conditions can be utilized in numerous combinations so as to achieve corresponding effect.

According to the above description of the present disclosure, the following specific embodiments are provided for further explanation.

### 1st Embodiment

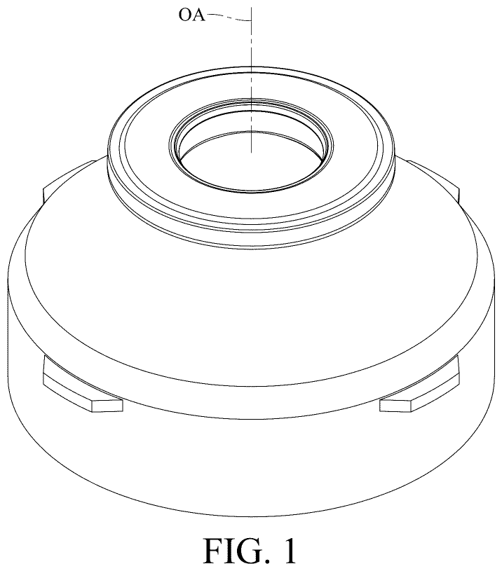

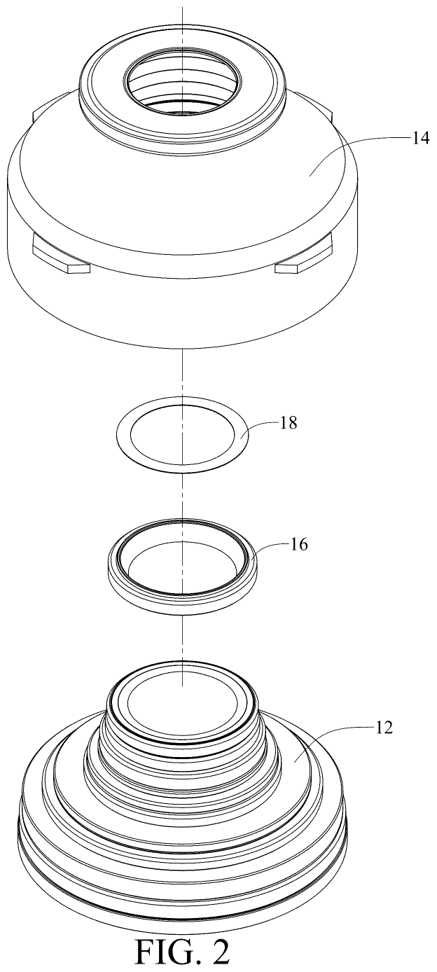

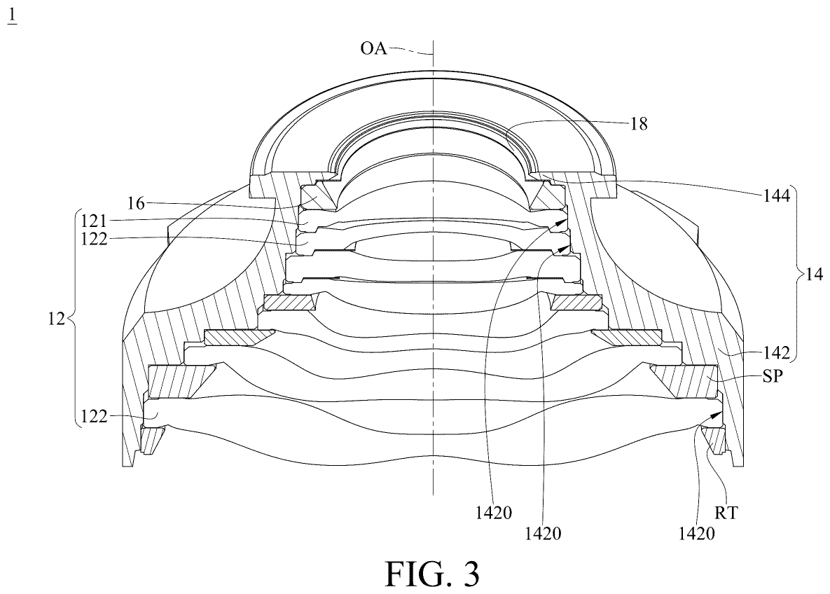

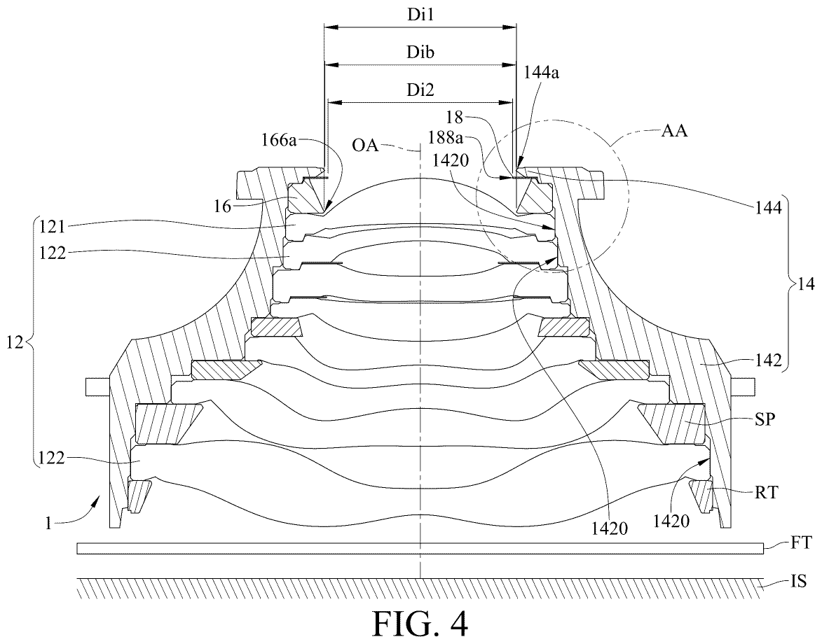

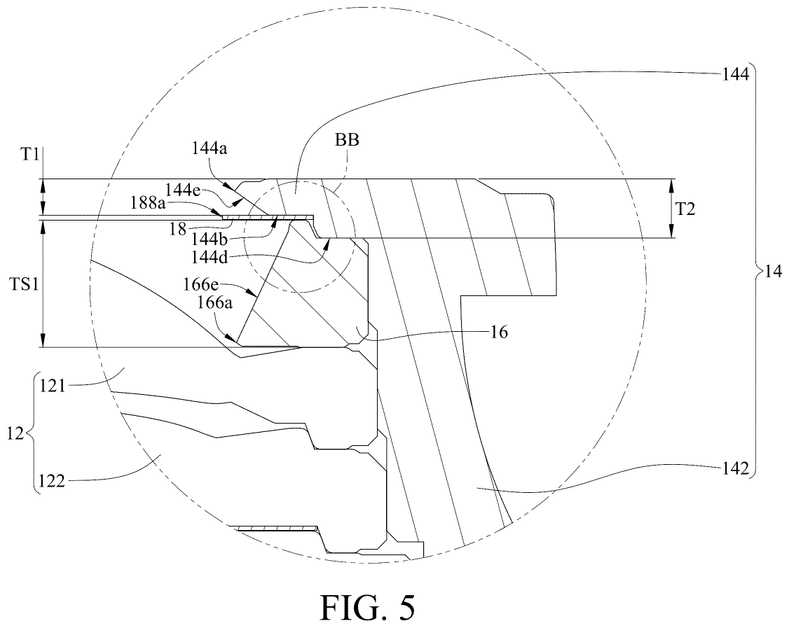

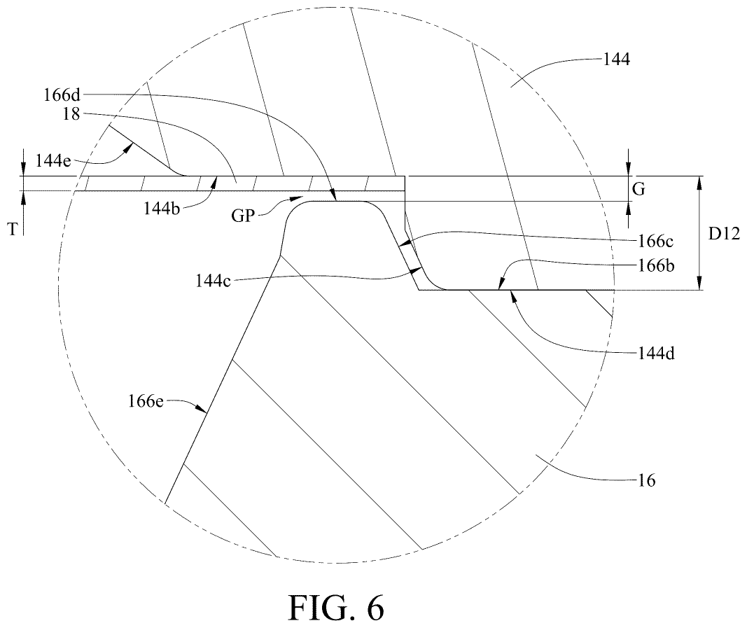

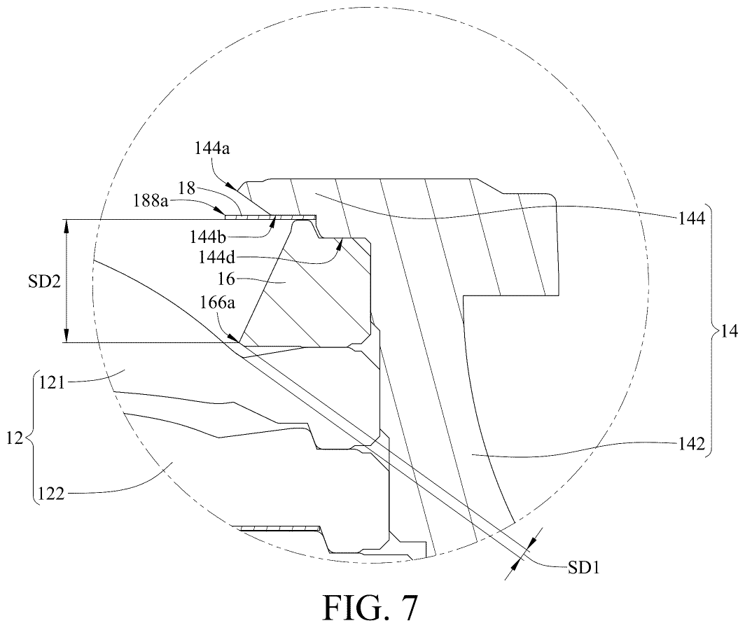

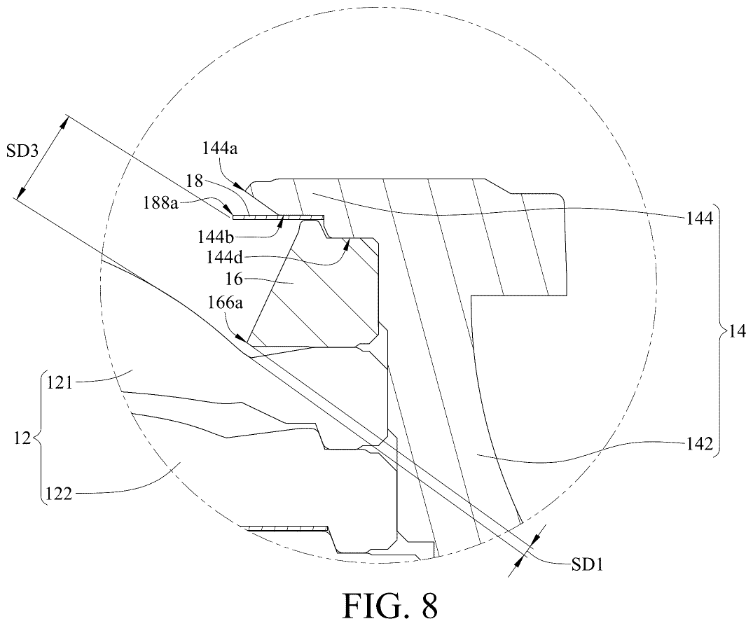

Please refer to FIG. 1 to FIG. 8, where FIG. 1 is a perspective view of an imaging lens according to the 1st embodiment of the present disclosure, FIG. 2 is an exploded view of the imaging lens in FIG. 1, FIG. 3 is a perspective view of the imaging lens in FIG. 1 that has been sectioned, FIG. 4 is a cross-sectional view of the imaging lens in FIG. 1, FIG. 5 is an enlarged view of AA region of the imaging lens in FIG. 4, FIG. 6 is an enlarged view of BB region of the imaging lens in FIG. 5, FIG. 7 is another schematic view of the imaging lens in FIG. 5, and FIG. 8 is further another schematic view of the imaging lens in FIG. 5.

An imaging lens 1 provided in this embodiment includes a plurality of lens elements 12, a lens barrel 14, a first opening element 16 and a second opening element 18.

The lens elements 12 are sequentially arranged along an optical axis OA. The lens elements 12 include a first lens element 121 and a plurality of remaining lens elements 122. The first lens element 121 is one of the lens elements 12 closest to an object side of the imaging lens 1. It can also be considered that the first lens element 121 is located closer to the object side of the imaging lens 1 than the remaining lens elements 122. The imaging lens 1 further includes a spacer SP configured to space the lens elements 12 and a retainer RT configured to hold the lens elements 12.

The lens barrel 14 includes a tube portion 142 and an opening portion 144.

The tube portion 142 surrounds the optical axis OA, and the tube portion 142 has a plurality of inner bore surfaces 1420 configured for components such as the lens elements 12, the first opening element 16, the spacer SP and the retainer RT to be disposed thereon.

The opening portion 144 extends along a direction from the tube portion 142 towards the optical axis OA. The opening portion 144 has a barrel opening 144a, a first step surface 144b, a first connection surface 144c and a second step surface 144d.

The barrel opening 144a is located on an object side of the first lens element 121.

The first step surface 144b is located closer to the optical axis OA than the second step surface 144d. The first step surface 144b is located closer to the barrel opening 144a than the second step surface 144d.

The first connection surface 144c connects the first step surface 144b and the second step surface 144d.

The second step surface 144d is at least partially overlapped with the first lens element 121 in a direction parallel to the optical axis OA.

The first opening element 16 is disposed between the first lens element 121 and the opening portion 144 to space the first lens element 121 apart from the opening portion 144. The first opening element 16 has a side away from the opening portion 144 on which the first lens element 121 abuts, thereby maintaining the distance between the first lens element 121 and the barrel opening 144a. The first opening element 16 and the first step surface 144b form a gap GP therebetween. The first opening element 16 has a first light-passable opening 166a, a third step surface 166b, a second connection surface 166c and a fourth step surface 166d.

The first light-passable opening 166a is disposed corresponding to the barrel opening 144a.

The third step surface 166b of the first opening element 16 is in physical contact with the second step surface 144d of the opening portion 144.

The second connection surface 166c extends along a direction from a side of the third step surface 166b close to the optical axis OA towards the first step surface 144b. The second connection surface 166c is disposed spaced apart from the first connection surface 144c.

The fourth step surface 166d extends along a direction from a side of the second connection surface 166c close to the first step surface 144b towards the optical axis OA. The fourth step surface 166d and the first step surface 144b form the abovementioned gap GP therebetween.

The second opening element 18 is a light-blocking sheet. The second opening element 18 is disposed in the gap GP. The second opening element 18 is in contact with the opening portion 144 through both the first step surface 144b and the first connection surface 144c. The second opening element 18 has a second light-passable opening 188a disposed opposite to the first light-passable opening 166a.

In this embodiment, the opening portion 144 further has a first conical surface 144e inclined away from the optical axis OA along a direction from the barrel opening 144a towards the second opening element 18.

The first opening element 16 further has a second conical surface 166e inclined away from the optical axis OA along a direction from the first light-passable opening 166a towards the second opening element 18.

As shown in FIG. 5, a minimum thickness T1 of the opening portion 144 at the first step surface 144b in a direction parallel to the optical axis OA is less than a minimum thickness T2 of the opening portion 144 at the second step surface 144d in a direction parallel to the optical axis OA.

As shown in FIG. 7, a shortest distance SD1 between the first lens element 121 and the first light-passable opening 166a is less than a shortest distance SD2 between the second opening element 18 and the first light-passable opening 166a.

As shown in FIG. 8, the shortest distance SD1 between the first lens element 121 and the first light-passable opening 166a is less than a shortest distance SD3 between the first lens element 121 and the second light-passable opening 188a.

When a minimum width of the gap GP between the first step surface 144band the first opening element 16 in a direction parallel to the optical axis OA is G, and a shortest distance in a direction parallel to the optical axis OA between the first step surface 144b and the second step surface 144d is D12, the following conditions are satisfied: G=0.03 mm; D12=0.12 mm; and G/D12=0.25.

When the minimum width of the gap GP between the first step surface 144b and the first opening element 16 in the direction parallel to the optical axis OA is G, and a thickness of the light-blocking sheet is T, the following conditions are satisfied: G=0.03 mm; T=0.016 mm; and G/T=1.875.

Each of the barrel opening 144a, the first light-passable opening 166a and the second light-passable opening 188a has a maximum opening diameter. When the maximum opening diameter of the barrel opening 144a is Dib, the maximum opening diameter of the first light-passable opening 166a is Di1, and the maximum opening diameter of the second light-passable opening 188a is Di2, the following conditions are satisfied: Dib=3.76 mm; Di1=3.78 mm; Di2=3.63 mm; Dib/Di2=1.036; and Di1/Di2=1.041.

When the minimum thickness of the opening portion 144 at the first step surface 144b in the direction parallel to the optical axis OA is T1, and a thickness of the first opening element 16 in a direction parallel to the optical axis OA is TS1, the following conditions are satisfied: T1=0.196 mm; TS1=0.686 mm; and T1/TS1=0.286.

### 2nd Embodiment

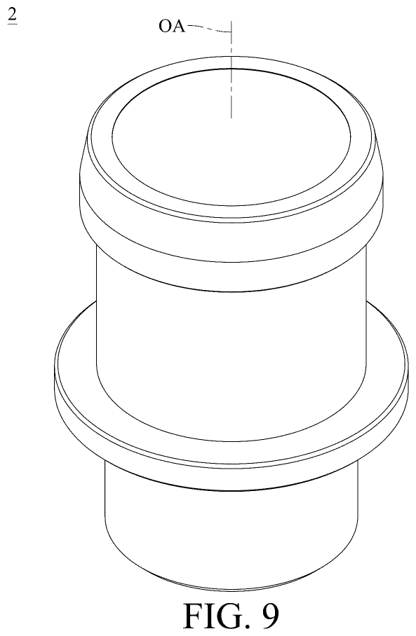

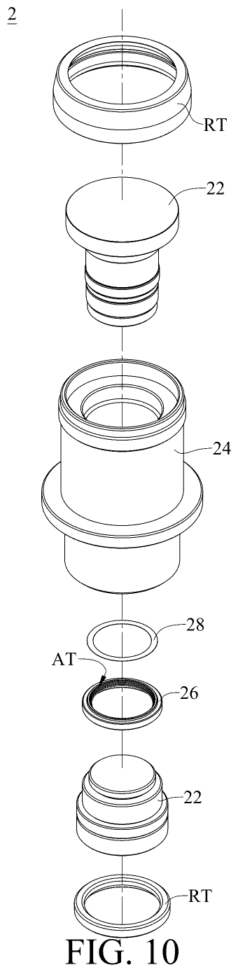

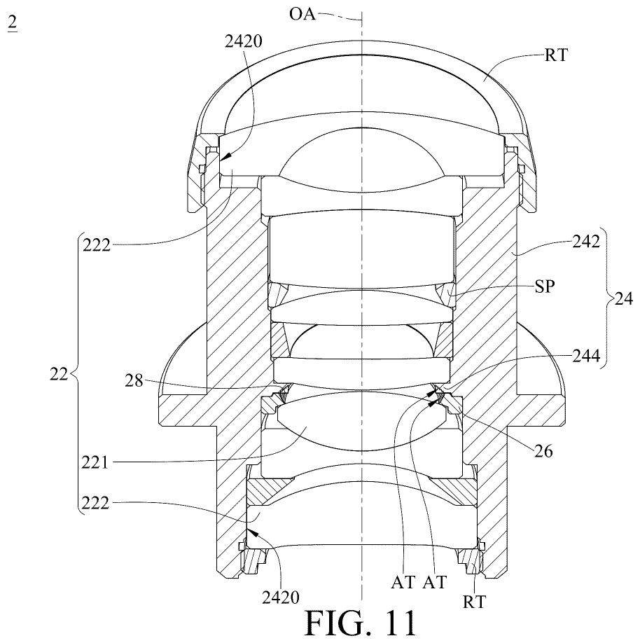

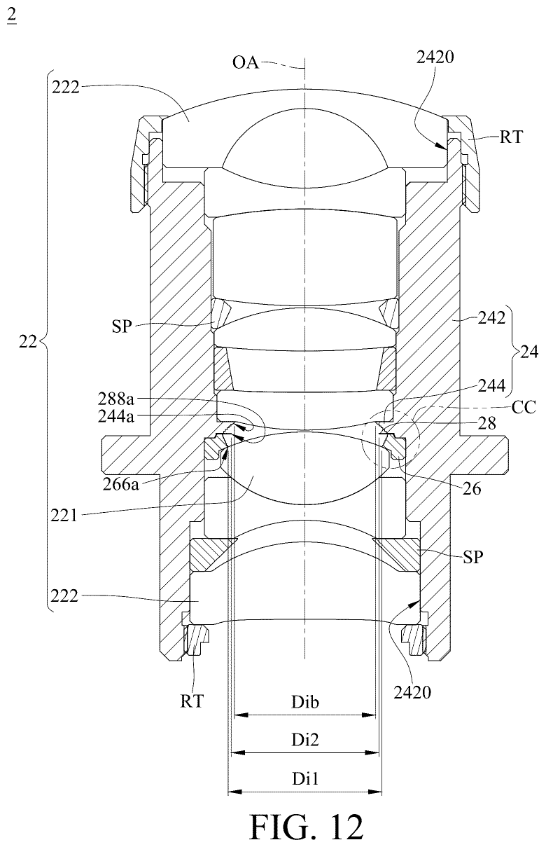

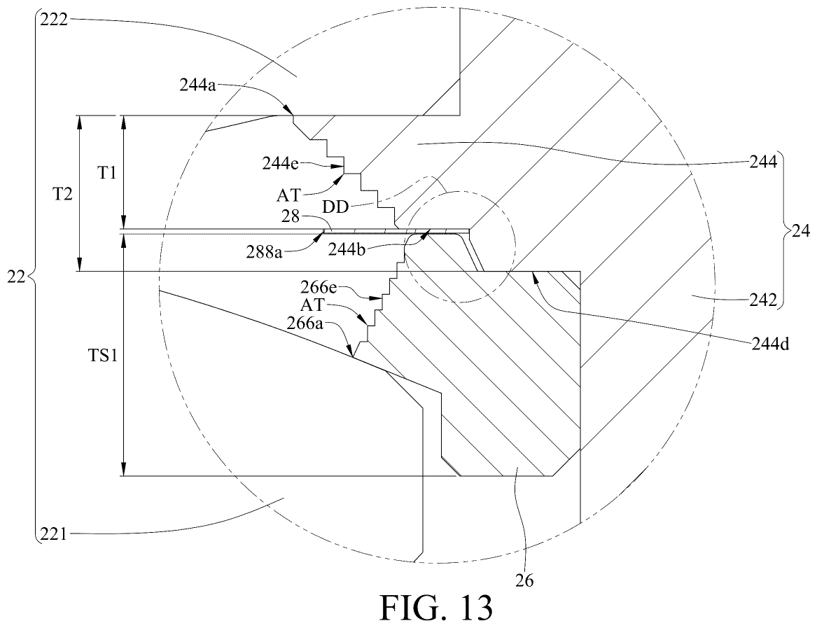

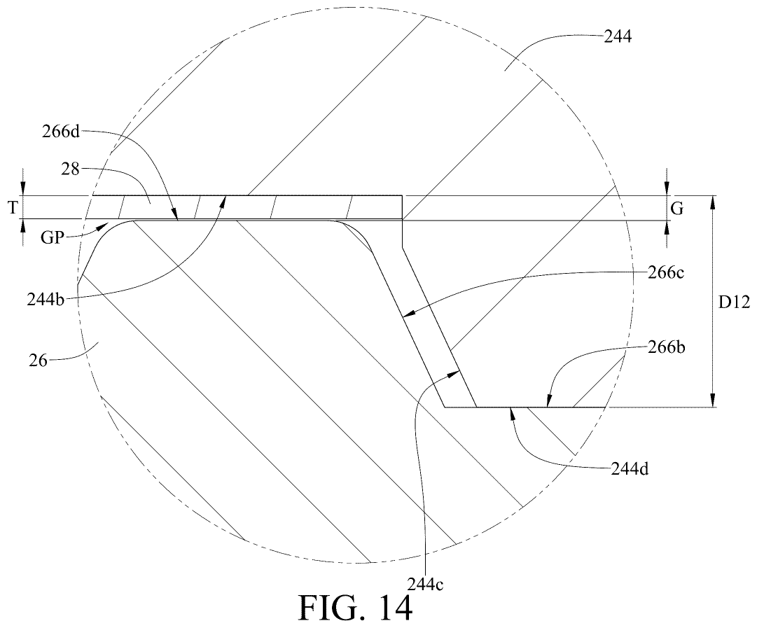

Please refer to FIG. 9 to FIG. 14, where FIG. 9 is a perspective view of an imaging lens according to the 2nd embodiment of the present disclosure, FIG. 10 is an exploded view of the imaging lens in FIG. 9, FIG. 11 is a perspective view of the imaging lens in FIG. 9 that has been sectioned, FIG. 12 is a cross-sectional view of the imaging lens in FIG. 9, FIG. 13 is an enlarged view of CC region of the imaging lens in FIG. 12, and FIG. 14 is an enlarged view of DD region of the imaging lens in FIG. 13.

An imaging lens 2 provided in this embodiment includes a plurality of lens elements 22, a lens barrel 24, a first opening element 26 and a second opening element 28.

The lens elements 22 are sequentially arranged along an optical axis OA. The lens elements 22 include a first lens element 221 and a plurality of remaining lens elements 222. The first lens element 221 is located between the remaining lens elements 222. The imaging lens 2 further includes a spacer SP configured to space the lens elements 22 and a retainer RT configured to hold the lens elements 22.

The lens barrel 24 includes a tube portion 242 and an opening portion 244.

The tube portion 242 surrounds the optical axis OA, and the tube portion 242 has a plurality of inner bore surfaces 2420 configured for components such as the lens elements 22, the first opening element 26, the spacer SP and the retainer RT to be disposed thereon.

The opening portion 244 extends along a direction from the tube portion 242 towards the optical axis OA. The opening portion 244 has a barrel opening 244a, a first step surface 244b, a first connection surface 244c and a second step surface 244d.

The barrel opening 244a is located on an object side of the first lens element 221.

The first step surface 244b is located closer to the optical axis OA than the second step surface 244d. The first step surface 244b is located closer to the barrel opening 244a than the second step surface 244d.

The first connection surface 244c connects the first step surface 244b and the second step surface 244d.

The first opening element 26 is disposed between the first lens element 221 and the opening portion 244 to space the first lens element 221 apart from the opening portion 244. The first opening element 26 has a side away from the opening portion 244 on which the first lens element 221 abuts, thereby maintaining the distance between the first lens element 221 and the barrel opening 244a. The first opening element 26 and the first step surface 244b form a gap GP therebetween. The first opening element 26 has a first light-passable opening 266a, a third step surface 266b, a second connection surface 266c and a fourth step surface 266d.

The first light-passable opening 266a is disposed corresponding to the barrel opening 244a.

The third step surface 266b of the first opening element 26 is in physical contact with the second step surface 244d of the opening portion 244.

The second connection surface 266c extends along a direction from a side of the third step surface 266b close to the optical axis OA towards the first step surface 244b. The second connection surface 266c is disposed spaced apart from the first connection surface 244c.

The fourth step surface 266d extends along a direction from a side of the second connection surface 266c close to the first step surface 244b towards the optical axis OA. The fourth step surface 266d and the first step surface 244b form the abovementioned gap GP therebetween.

The second opening element 28 is a light-blocking sheet. The second opening element 28 is disposed in the gap GP. The second opening element 28 is in contact with the opening portion 244 through both the first step surface 244b and the first connection surface 244c. The second opening element 28 has a second light-passable opening 288a disposed opposite to the first light-passable opening 266a.

In this embodiment, the opening portion 244 further has a first conical surface 244e inclined away from the optical axis OA along a direction from the barrel opening 244a towards the second opening element 28.

The first opening element 26 further has a second conical surface 266e inclined away from the optical axis OA along a direction from the first light-passable opening 266a towards the second opening element 28.

Each of the first conical surface 244e and the second conical surface 266e includes an anti-reflection structure AT surrounding the optical axis OA. The anti-reflection structure AT includes a plurality of protrusions (not numbered). The protrusions are annular to surround the optical axis OA and are sequentially arranged along a direction away from the optical axis OA.

As shown in FIG. 13, a minimum thickness T1 of the opening portion 244 at the first step surface 244b in a direction parallel to the optical axis OA is less than a minimum thickness T2 of the opening portion 244 at the second step surface 244d in a direction parallel to the optical axis OA.

When a minimum width of the gap GP between the first step surface 244b and the first opening element 26 in a direction parallel to the optical axis OA is G, and a shortest distance in a direction parallel to the optical axis OA between the first step surface 244b and the second step surface 244d is D12, the following conditions are satisfied: G=0.03 mm; D12=0.23 mm; and G/D12=0.130.

When the minimum width of the gap GP between the first step surface 244b and the first opening element 26 in the direction parallel to the optical axis OA is G, and a thickness of the light-blocking sheet is T, the following conditions are satisfied: G=0.03 mm; T=0.025 mm; and G/T=1.2.

Each of the barrel opening 244a, the first light-passable opening 266a and the second light-passable opening 288a has a maximum opening diameter. When the maximum opening diameter of the barrel opening 244a is Dib, the maximum opening diameter of the first light-passable opening 266a is Di1, and the maximum opening diameter of the second light-passable opening 288a is Di2, the following conditions are satisfied: Dib=7.3 mm; Di1=7.94 mm; Di2=7.63 mm; Dib/Di2=0.957; and Di1/Di2=1.041.

When the minimum thickness of the opening portion 244 at the first step surface 244b in the direction parallel to the optical axis OA is T1, and a thickness of the first opening element 26 in a direction parallel to the optical axis OA is TS1, the following conditions are satisfied: T1=0.612 mm; TS1=1.306 mm; and T1/TS1=0.469.

### 3rd Embodiment

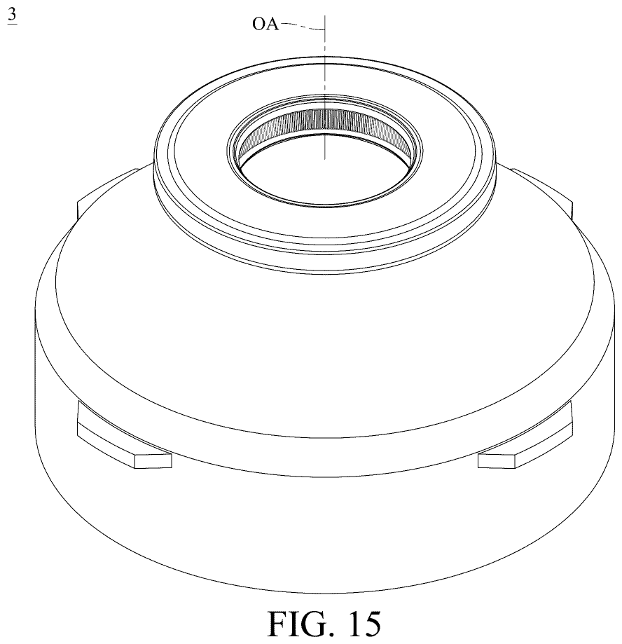

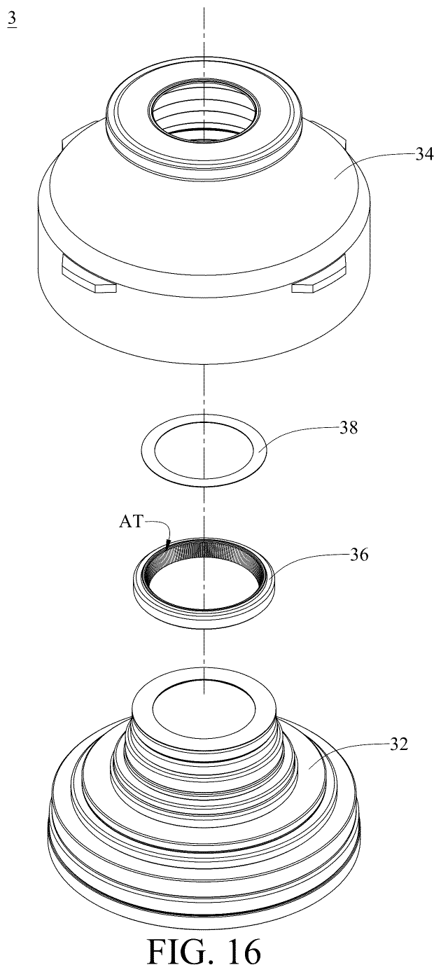

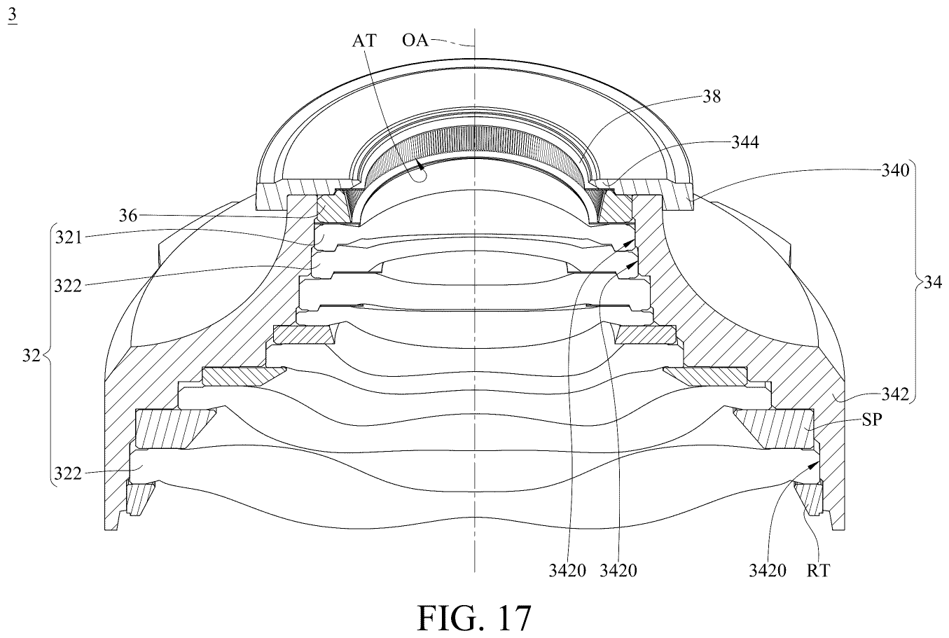

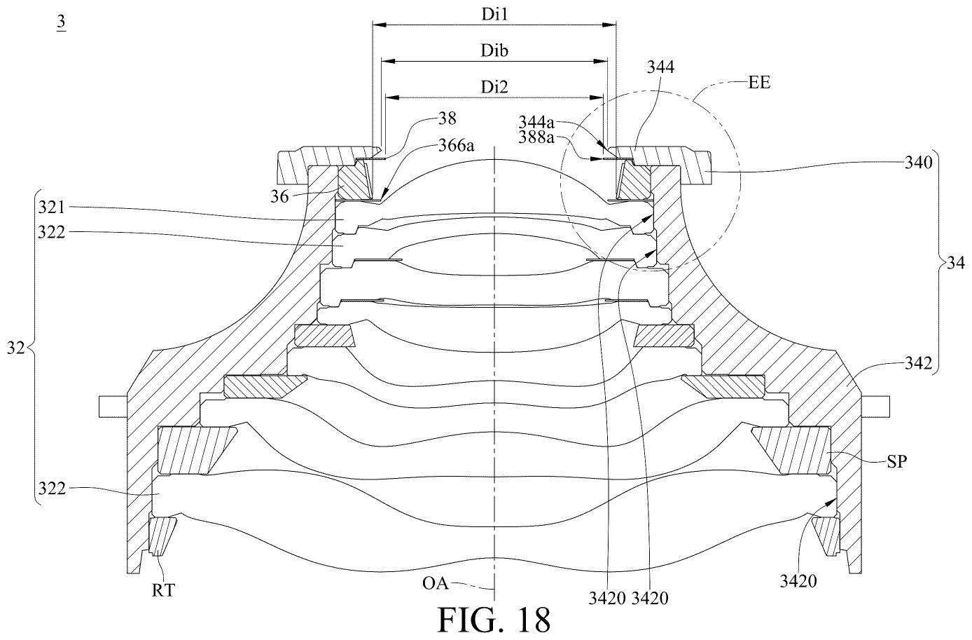

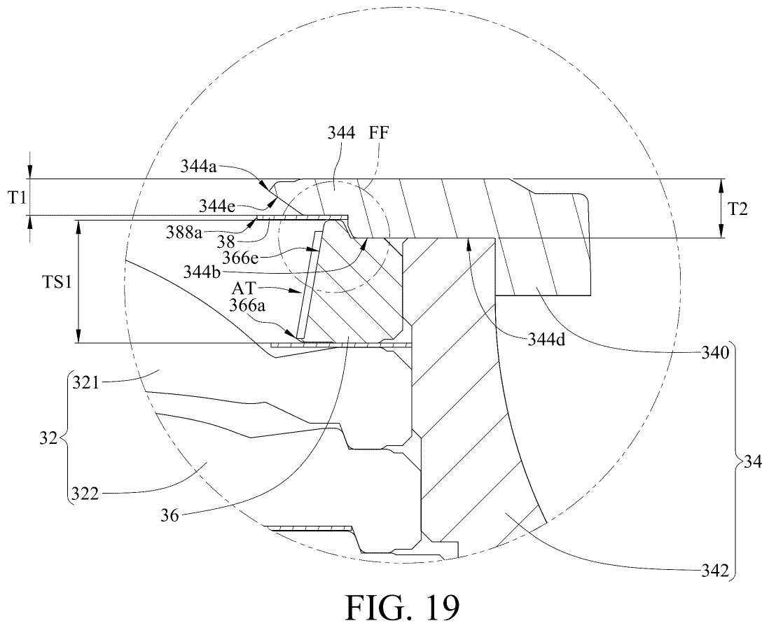

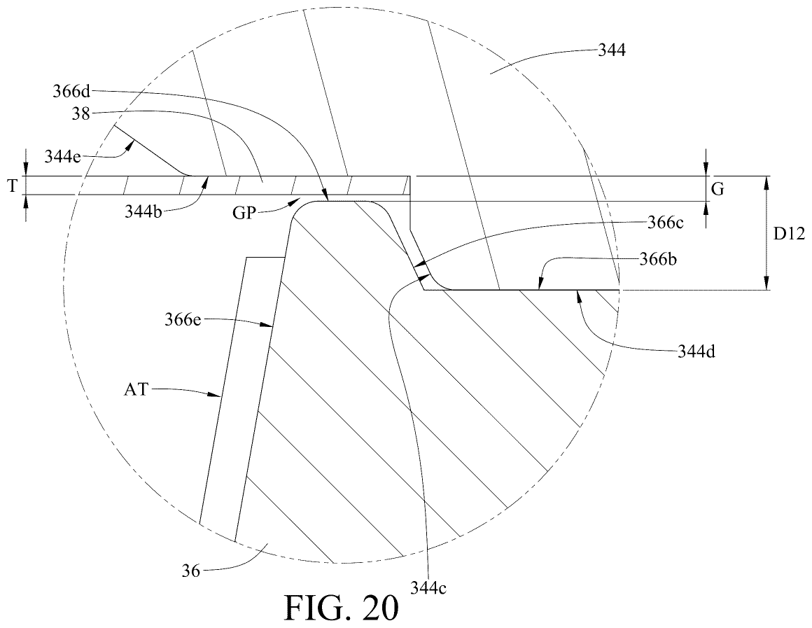

Please refer to FIG. 15 to FIG. 20, where FIG. 15 is a perspective view of an imaging lens according to the 3rd embodiment of the present disclosure, FIG. 16 is an exploded view of the imaging lens in FIG. 15, FIG. 17 is a perspective view of the imaging lens in FIG. 15 that has been sectioned, FIG. 18 is a cross-sectional view of the imaging lens in FIG. 15, FIG. 19 is an enlarged view of EE region of the imaging lens in FIG. 18, and FIG. 20 is an enlarged view of FF region of the imaging lens in FIG. 19.

An imaging lens 3 provided in this embodiment includes a plurality of lens elements 32, a lens barrel 34, a first opening element 36 and a second opening element 38.

The lens elements 32 are sequentially arranged along an optical axis OA. The lens elements 32 include a first lens element 321 and a plurality of remaining lens elements 322. The first lens element 321 is one of the lens elements 32 closest to an object side of the imaging lens 3. It can also be considered that the first lens element 321 is located closer to the object side of the imaging lens 3 than the remaining lens elements 322. The imaging lens 3 further includes a spacer SP configured to space the lens elements 32 and a retainer RT configured to hold the lens elements 32.

The lens barrel 34 includes a barrel opening element 340. In specific, the lens barrel 34 includes a tube portion 342 and the abovementioned barrel opening element 340 fixed on the tube portion 342, and the barrel opening element 340 includes an opening portion 344.

The tube portion 342 surrounds the optical axis OA, and the tube portion 342 has a plurality of inner bore surfaces 3420 configured for components such as the lens elements 32, the first opening element 36, the spacer SP and the retainer RT to be disposed thereon.

The opening portion 344 extends along a direction towards the optical axis OA. The opening portion 344 has a barrel opening 344a, a first step surface 344b, a first connection surface 344c and a second step surface 344d.

The barrel opening 344a is located on an object side of the first lens element 321.

The first step surface 344b is located closer to the optical axis OA than the second step surface 344d. The first step surface 344b is located closer to the barrel opening 344a than the second step surface 344d.

The first connection surface 344c connects the first step surface 344b and the second step surface 344d.

The second step surface 344d is at least partially overlapped with the first lens element 321 in a direction parallel to the optical axis OA.

The first opening element 36 is disposed between the first lens element 321 and the opening portion 344 to space the first lens element 321 apart from the opening portion 344. The first opening element 36 has a side away from the opening portion 344 on which the first lens element 321 abuts, thereby maintaining the distance between the first lens element 321 and the barrel opening 344a. The first opening element 36 and the first step surface 344b form a gap GP therebetween. The first opening element 36 has a first light-passable opening 366a, a third step surface 366b, a second connection surface 366c and a fourth step surface 366d.

The first light-passable opening 366a is disposed corresponding to the barrel opening 344a.

The third step surface 366b of the first opening element 36 is in physical contact with the second step surface 344d of the opening portion 344.

The second connection surface 366c extends along a direction from a side of the third step surface 366b close to the optical axis OA towards the first step surface 344b. The second connection surface 366c is disposed spaced apart from the first connection surface 344c.

The fourth step surface 366d extends along a direction from a side of the second connection surface 366c close to the first step surface 344b towards the optical axis OA. The fourth step surface 366d and the first step surface 344b form the abovementioned gap GP therebetween.

The second opening element 38 is a light-blocking sheet. The second opening element 38 is disposed in the gap GP. The second opening element 38 is in contact with the opening portion 344 through both the first step surface 344b and the first connection surface 344c. The second opening element 38 has a second light-passable opening 388a disposed opposite to the first light-passable opening 366a.

In this embodiment, the opening portion 344 further has a first conical surface 344e inclined away from the optical axis OA along a direction from the barrel opening 344a towards the second opening element 38.

The first opening element 36 further has a second conical surface 366e inclined away from the optical axis OA along a direction from the first light-passable opening 366a towards the second opening element 38.

The second conical surface 366e includes an anti-reflection structure AT surrounding the optical axis OA. The anti-reflection structure AT includes a plurality of protrusions (not numbered). The protrusions are linear to be angled to the optical axis OA and are sequentially arranged along a direction surrounding the optical axis OA.

As shown in FIG. 19, a minimum thickness T1 of the opening portion 344 at the first step surface 344b in a direction parallel to the optical axis OA is less than a minimum thickness T2 of the opening portion 344 at the second step surface 344d in a direction parallel to the optical axis OA.

When a minimum width of the gap GP between the first step surface 344b and the first opening element 36 in a direction parallel to the optical axis OA is G, and a shortest distance in a direction parallel to the optical axis OA between the first step surface 344b and the second step surface 344d is D12, the following conditions are satisfied: G=0.03 mm; D12=0.12 mm; and G/D12=0.25.

When the minimum width of the gap GP between the first step surface 344b and the first opening element 36 in the direction parallel to the optical axis OA is G, and a thickness of the light-blocking sheet is T, the following conditions are satisfied: G=0.03 mm; T=0.02 mm; and G/T=1.5.

Each of the barrel opening 344a, the first light-passable opening 366a and the second light-passable opening 388a has a maximum opening diameter. When the maximum opening diameter of the barrel opening 344a is Dib, the maximum opening diameter of the first light-passable opening 366a is Di1, and the maximum opening diameter of the second light-passable opening 388a is Di2, the following conditions are satisfied: Dib=3.76 mm; Di1=4.05 mm; Di2=3.63 mm; Dib/Di2=1.036; and Di1/Di2=1.116.

When the minimum thickness of the opening portion 344 at the first step surface 344b in the direction parallel to the optical axis OA is T1, and a thickness of the first opening element 36 in a direction parallel to the optical axis OA is TS1, the following conditions are satisfied: T1=0.196 mm; TS1=0.663 mm; and T1/TS1=0.296.

### 4th Embodiment

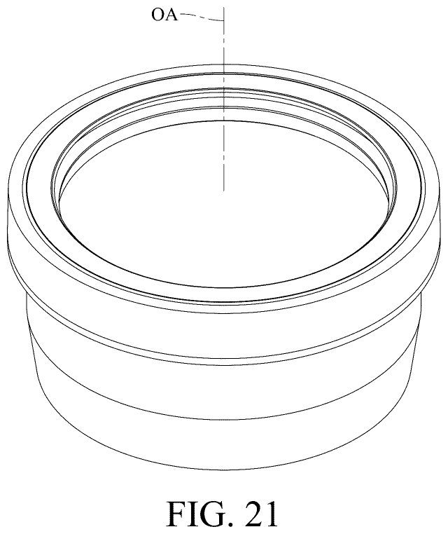

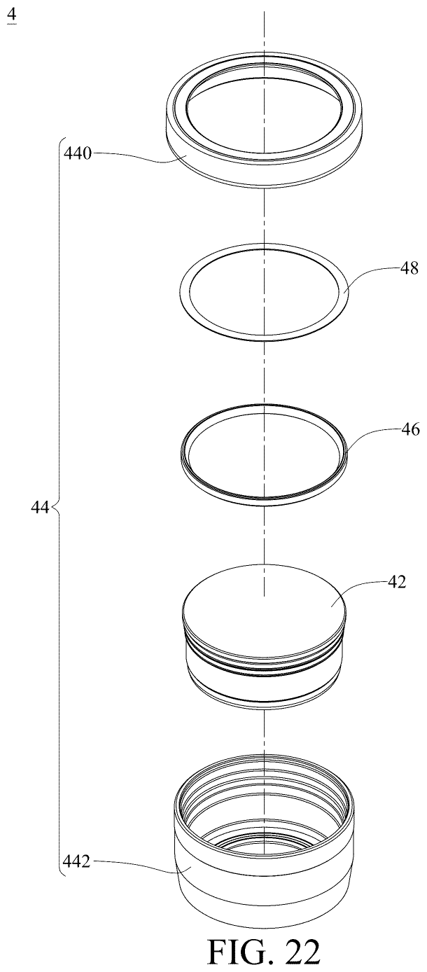

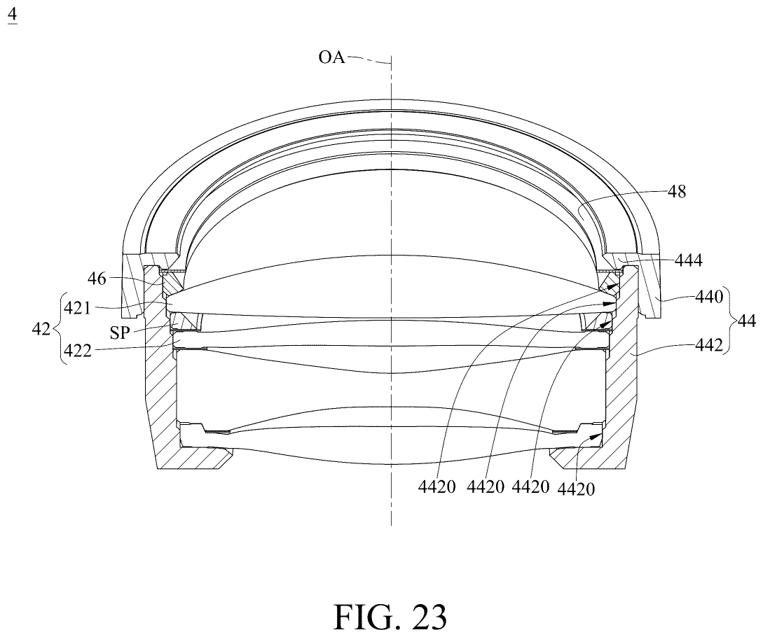

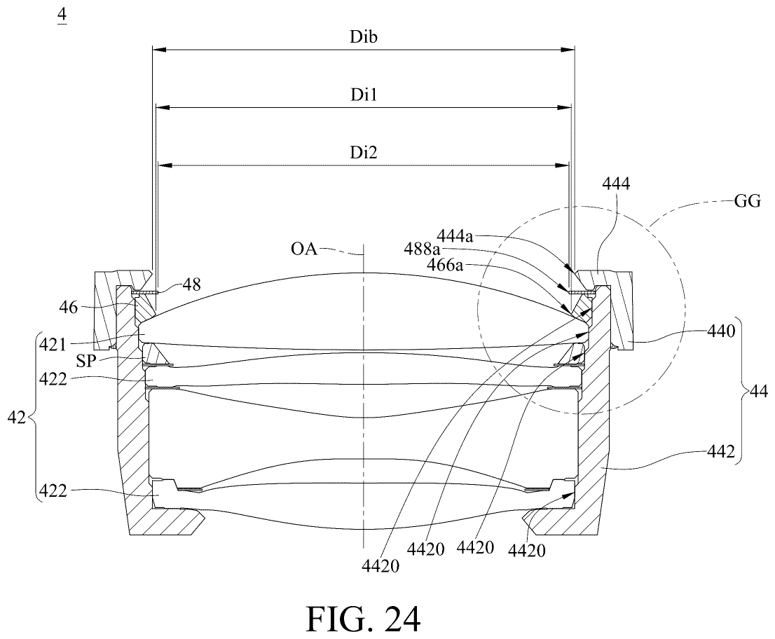

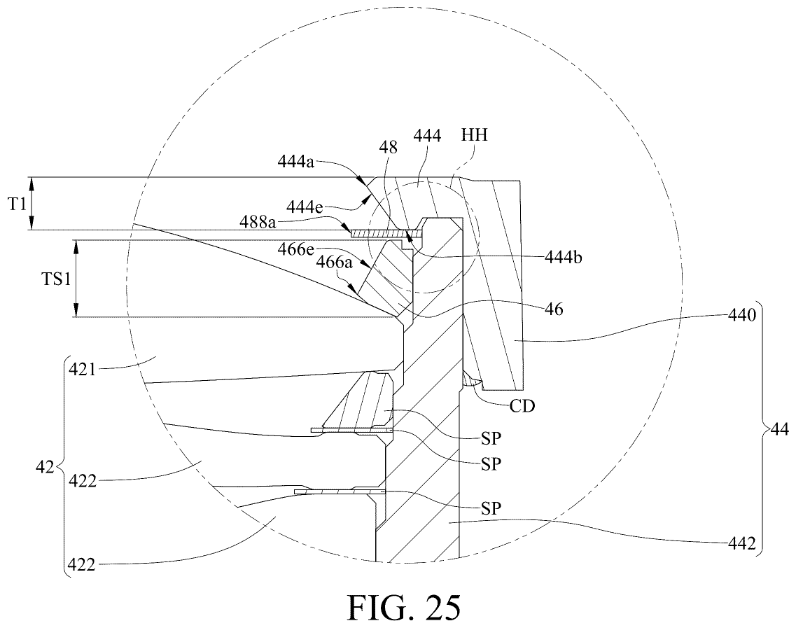

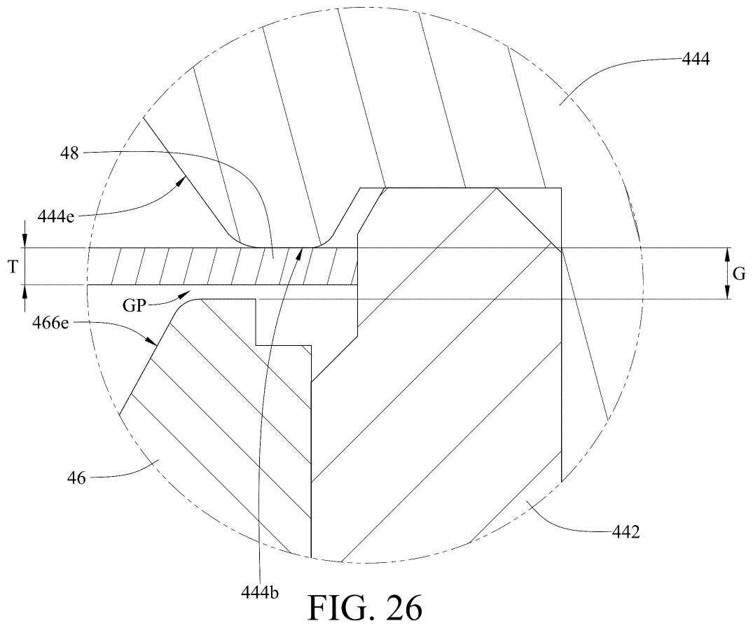

Please refer to FIG. 21 to FIG. 26, where FIG. 21 is a perspective view of an imaging lens according to the 4th embodiment of the present disclosure, FIG. 22 is an exploded view of the imaging lens in FIG. 21, FIG. 23 is a perspective view of the imaging lens in FIG. 21 that has been sectioned, FIG. 24 is a cross-sectional view of the imaging lens in FIG. 21, FIG. 25 is an enlarged view of GG region of the imaging lens in FIG. 24, and FIG. 26 is an enlarged view of HH region of the imaging lens in FIG. 25.

An imaging lens 4 provided in this embodiment includes a plurality of lens elements 42, a lens barrel 44, a first opening element 46 and a second opening element 48.

The lens elements 42 are sequentially arranged along an optical axis OA. The lens elements 42 include a first lens element 421 and a plurality of remaining lens elements 422. The first lens element 421 is one of the lens elements 42 closest to an object side of the imaging lens 4. It can also be considered that the first lens element 421 is located closer to the object side of the imaging lens 4 than the remaining lens elements 422. The imaging lens 4 further includes a spacer SP configured to space the lens elements 42.

The lens barrel 44 includes a barrel opening element 440. In specific, the lens barrel 44 includes a tube portion 442 and the abovementioned barrel opening element 440 fixed on the tube portion 442 through colloid CD, and the barrel opening element 440 includes an opening portion 444.

The tube portion 442 surrounds the optical axis OA, and the tube portion 442 has a plurality of inner bore surfaces 4420 configured for components such as the lens elements 42, the first opening element 46, the second opening element 48 and the spacer SP to be disposed thereon.

The opening portion 444 extends along a direction towards the optical axis OA. The opening portion 444 has a barrel opening 444a and a first step surface 444b.

The barrel opening 444a is located on an object side of the first lens element 421.

The first step surface 444b faces towards an image side of the imaging lens.

The first opening element 46 is disposed between the first lens element 421 and the opening portion 444 to space the first lens element 421 apart from the opening portion 444. The first opening element 46 has a side away from the opening portion 444 on which the first lens element 421 abuts, with the first opening element 46 fixed to one of the inner bore surfaces 4420, thereby maintaining the distance between the first lens element 421 and the barrel opening 444a. The first opening element 46 and the first step surface 444b form a gap GP therebetween. The first opening element 46 has a first light-passable opening 466a.

The first light-passable opening 466a is disposed corresponding to the barrel opening 444a.

The second opening element 48 is a light-blocking sheet. The second opening element 48 is disposed in the gap GP. The second opening element 48 is in contact with the opening portion 444 through both the first step surface 444b and the first connection surface 444c. The second opening element 48 has a second light-passable opening 488a disposed opposite to the first light-passable opening 466a.

In this embodiment, the opening portion 444 further has a first conical surface 444e inclined away from the optical axis OA along a direction from the barrel opening 444a towards the second opening element 48.

The first opening element 46 further has a second conical surface 466e inclined away from the optical axis OA along a direction from the first light-passable opening 466a towards the second opening element 48.

When a minimum width of the gap GP between the first step surface 444b and the first opening element 46 in a direction parallel to the optical axis OA is G, and a thickness of the light-blocking sheet is T, the following conditions are satisfied: G=0.06 mm; T=0.04 mm; and G/T=1.5.

Each of the barrel opening 444a, the first light-passable opening 466a and the second light-passable opening 488a has a maximum opening diameter. When the maximum opening diameter of the barrel opening 444a is Dib, the maximum opening diameter of the first light-passable opening 466a is Di1, and the maximum opening diameter of the second light-passable opening 488a is Di2, the following conditions are satisfied: Dib=6.1 mm; Di1=6 mm; Di2=5.93 mm; Dib/Di2=1.029; and Di1/Di2=1.012.

When a minimum thickness of the opening portion 444 at the first step surface 444b in a direction parallel to the optical axis OA is T1, and a thickness of the first opening element 46 in a direction parallel to the optical axis OA is TS1, the following conditions are satisfied: T1=0.285 mm; TS1=0.415 mm; and T1/TS1=0.687.

### 5th Embodiment

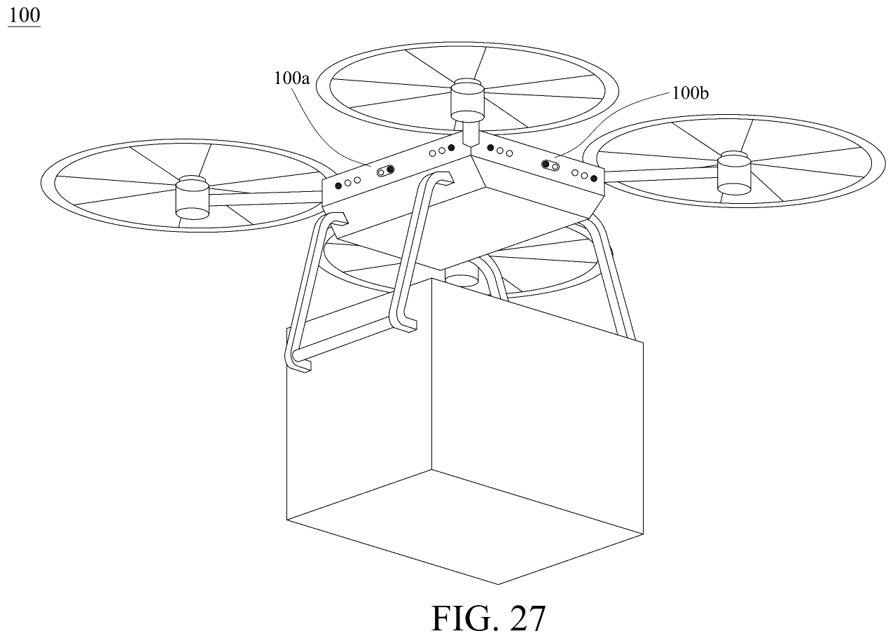

Please refer to FIG. 27, which is a perspective view of an electronic device according to the 5th embodiment of the present disclosure.

An electronic device 100 provided in this embodiment may be an unmanned aerial vehicle. The electronic device 100 includes a side image capturing unit 100a and a front image capturing unit 100b. The side image capturing unit 100a and the front image capturing unit 100b each include one of the imaging lenses 1-4 as disclosed in the 1st to 4th embodiments of the present disclosure so as to provide reliable optical quality and environmental durability of photography for the electronic device 100.

### 6th Embodiment

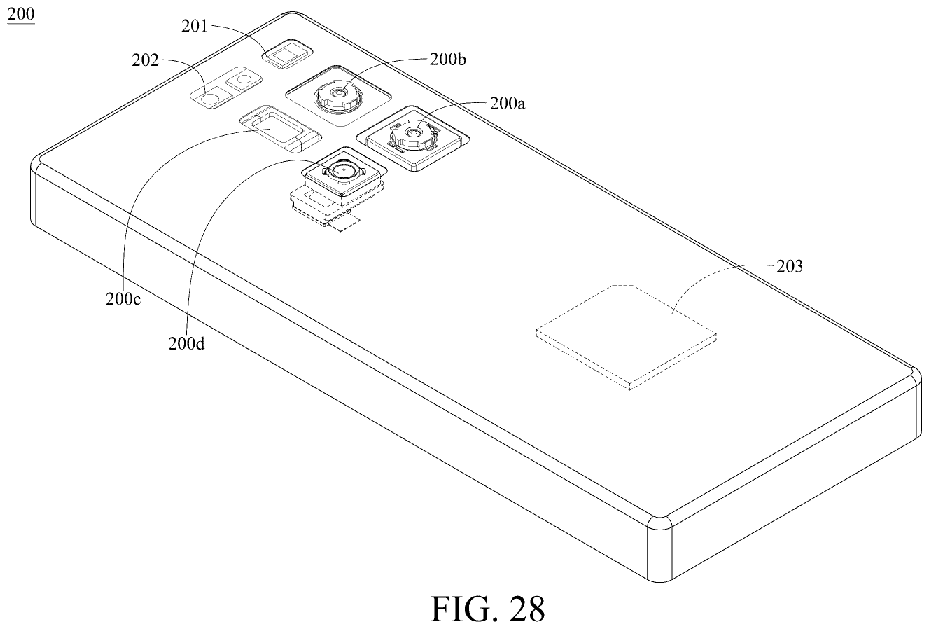

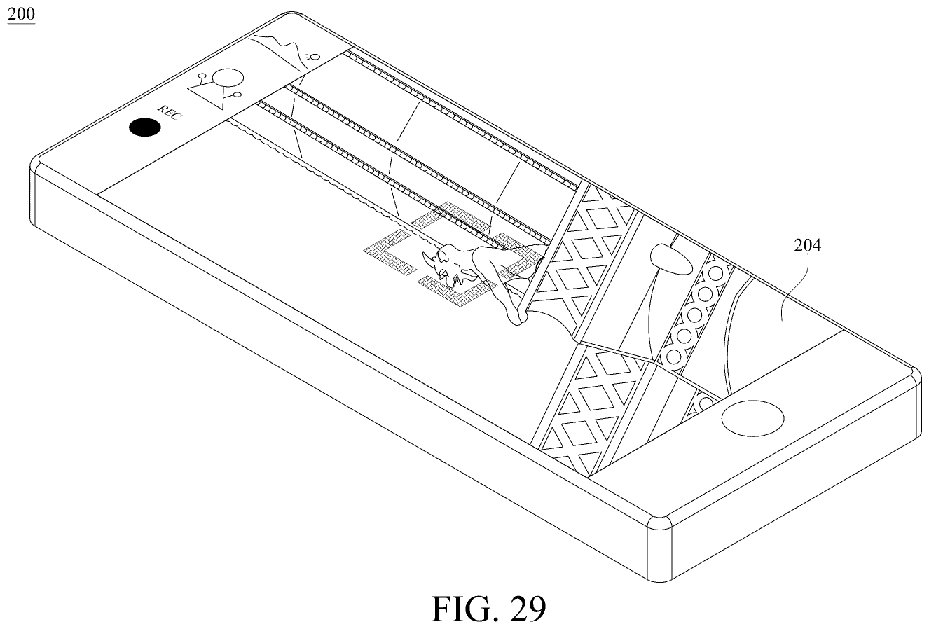

Please refer to FIG. 28 and FIG. 29. FIG. 28 is a perspective view of an electronic device according to the 6th embodiment of the present disclosure, and FIG. 29 is another perspective view of the electronic device in FIG. 28.

In this embodiment, the electronic device 200 is a smartphone including a plurality of image capturing units, a flash module 201, a focus assist module 202, an image signal processor 203, a display module (user interface) 204 and an image software processor (not shown).

These image capturing units include an ultra-wide-angle image capturing unit 200a, a high pixel image capturing unit 200b, a telephoto image capturing unit 200c and a telephoto image capturing unit 200d. Moreover, the image capturing unit 200b may include, for example, one of the imaging lenses 1-4 as disclosed in the 1st to 4th embodiments of the present disclosure and an image sensor assembly (not numbered). The image sensor assembly includes an image sensor IS (as illustrated in FIG. 4) disposed on an image surface of the imaging lens. Moreover, the image sensor assembly further include a filter FT (as illustrated in FIG. 4) disposed between the imaging lens and the image sensor IS. At least one of the image capturing units 200a, 200c, and 200d can include one of the imaging lenses 1-4 as disclosed in the 1st to 4th embodiments of the present disclosure, but the present disclosure is not limited thereto.

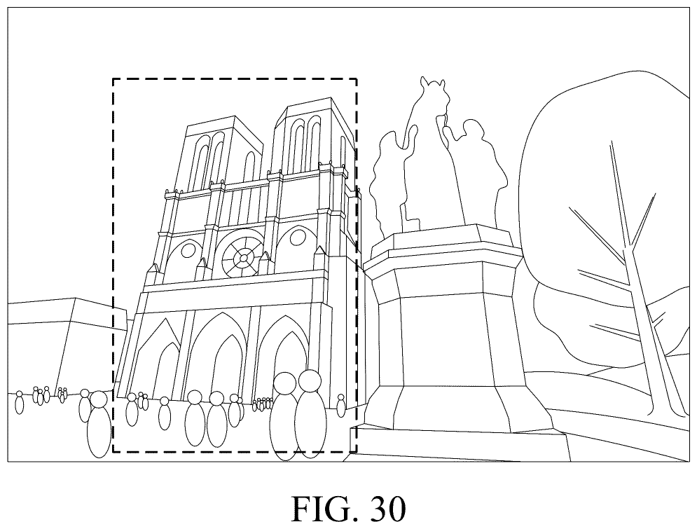

The image captured by the ultra-wide-angle image capturing unit 200a enjoys a feature of multiple imaged objects. FIG. 30 is an illustration of an image captured by the ultra-wide-angle image capturing unit 200a.

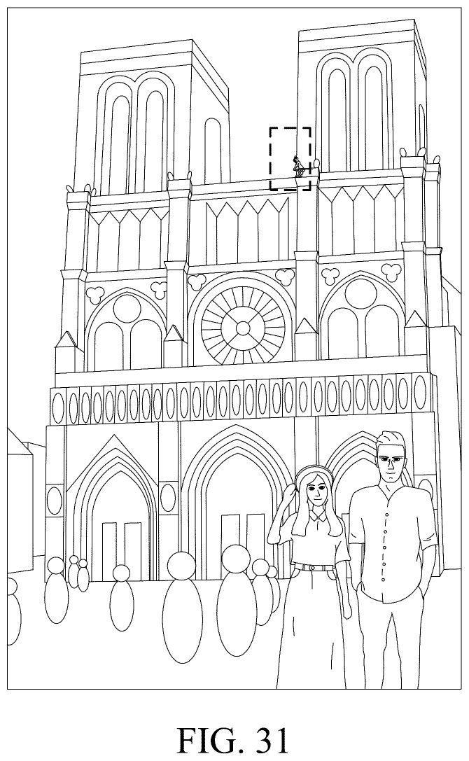

The image captured by the high pixel image capturing unit 200b enjoys a feature of high resolution and less distortion, and the high pixel image capturing unit 200b can capture part of the image in FIG. 30. FIG. 31 is an illustration of an image captured by the high pixel image capturing unit 200b.

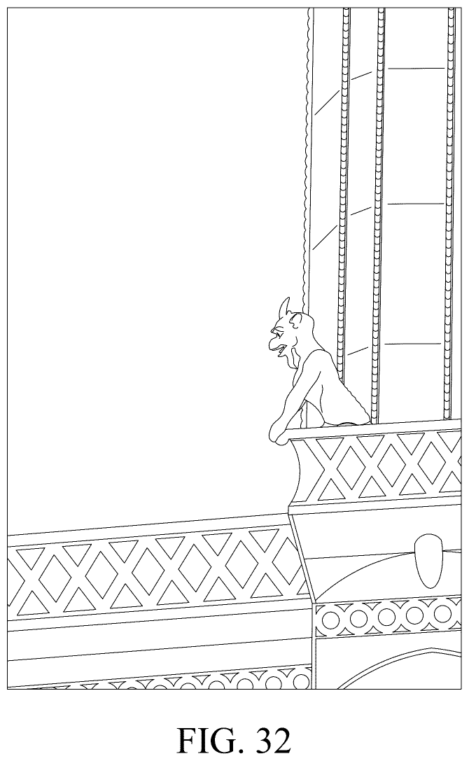

The image captured by the telephoto image capturing unit 200c or the telephoto image capturing unit 200d enjoys a feature of high optical magnification, and the telephoto image capturing unit 200c or the telephoto image capturing unit 200d can capture part of the image in FIG. 31. FIG. 32 is an illustration of an image captured by the telephoto image capturing unit 200c or the telephoto image capturing unit 200d.

When a user captures images of an object, the light rays converge in the ultra-wide-angle image capturing unit 200a, the high pixel image capturing unit 200b, the telephoto image capturing unit 200c or the telephoto image capturing unit 200d to generate an image, and the flash module 201 is activated for light supplement. The focus assist module 202 detects the object distance of the imaged object to achieve fast auto focusing. The image signal processor 203 is configured to optimize the captured image to improve image quality and provide zooming function. The light beam emitted from the focus assist module 202 can be either conventional infrared or laser. The display module 204 can include a touch screen, and the user is able to interact with the display module 204 to adjust the angle of view and switch between different image capturing units, and the image software processor having multiple functions to capture images and complete image processing. Alternatively, the user may capture images via a physical button. The image processed by the image software processor can be displayed on the display module 204.

### 7th Embodiment

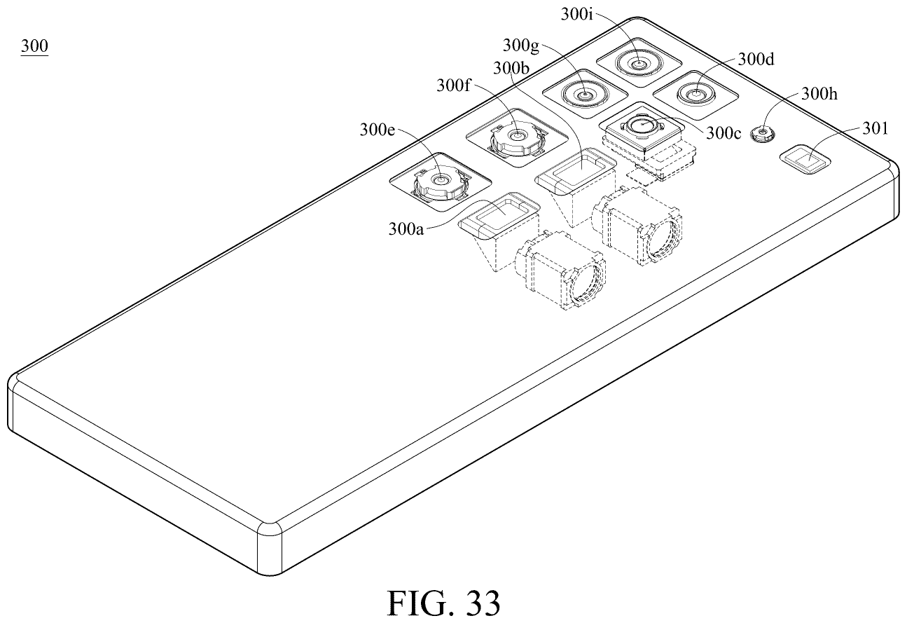

Please refer to FIG. 33, which is a perspective view of an electronic device according to the 7th embodiment of the present disclosure.

In this embodiment, the electronic device 300 is a smartphone including an image capturing unit 300a, an image capturing unit 300b, an image capturing unit 300c, an image capturing unit 300d, an image capturing unit 300e, an image capturing unit 300f, an image capturing unit 300g, an image capturing unit 300h, an image capturing unit 300i, a flash module 301, an image signal processor, a display module and an image software processor (not shown). The image capturing unit 300a, the image capturing unit 300b, the image capturing unit 300c, the image capturing unit 300d, the image capturing unit 300e, the image capturing unit 300f, the image capturing unit 300g, the image capturing unit 300h and the image capturing unit 300i are disposed on the same side of the electronic device 300, while the display module is disposed on the opposite side of the electronic device 300. Moreover, the image capturing unit 300e includes, for example, one of the imaging lenses 1-4 as disclosed in the 1st to 4th embodiments of the present disclosure, but the present disclosure is not limited thereto. At least one of the image capturing units 300a, 300b, 300c, 300d, 300f, 300g, 300h, and 300i can include one of the imaging lenses 1-4 as disclosed in the 1st to 4th embodiments of the present disclosure.

The image capturing unit 300a is a telephoto image capturing unit, the image capturing unit 300b is a telephoto image capturing unit, the image capturing unit 300c is a telephoto image capturing unit, the image capturing unit 300d is a telephoto image capturing unit, the image capturing unit 300e is a wide-angle image capturing unit, the image capturing unit 300f is a wide-angle image capturing unit, the image capturing unit 300g is a ultra-wide-angle image capturing unit, the image capturing unit 300h is a ToF (time of flight) image capturing unit, and the image capturing unit 300i is an ultra-wide-angle image capturing unit. In this embodiment, the image capturing unit 300i, the image capturing unit 300a, the image capturing unit 300b, the image capturing unit 300c, the image capturing unit 300d, the image capturing unit 300e, the image capturing unit 300f and the image capturing unit 300g have different fields of view, such that the electronic device 300 can have various magnification ratios so as to meet the requirement of optical zoom functionality. In addition, the image capturing unit 300a and image capturing unit 300b are telephoto image capturing units having a light-folding element configuration. In addition, the image capturing unit 300h can determine depth information of the imaged object. In this embodiment, the electronic device 300 includes multiple image capturing units 300a, 300b, 300c, 300d, 300e, 300f, 300g, 300h, and 300i, but the present disclosure is not limited to the quantity and arrangement of image capturing units. When a user captures images of an object, the light rays converge in the image capturing unit 300a, the image capturing unit 300b, the image capturing unit 300c, the image capturing unit 300d, the image capturing unit 300e, the image capturing unit 300f, the image capturing unit 300g, the image capturing unit 300h or the image capturing unit 300i to generate an image(s), and the flash module 301 is activated for light supplement. Further, the subsequent processes are performed in a manner similar to the abovementioned embodiments, so the details in this regard will not be provided again.

### 8th Embodiment

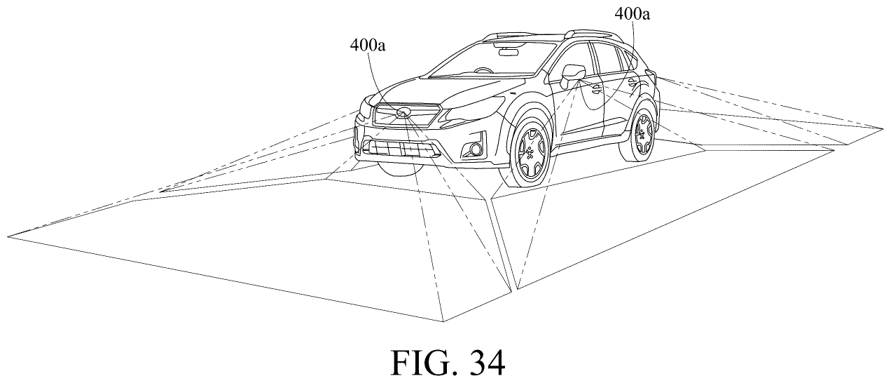

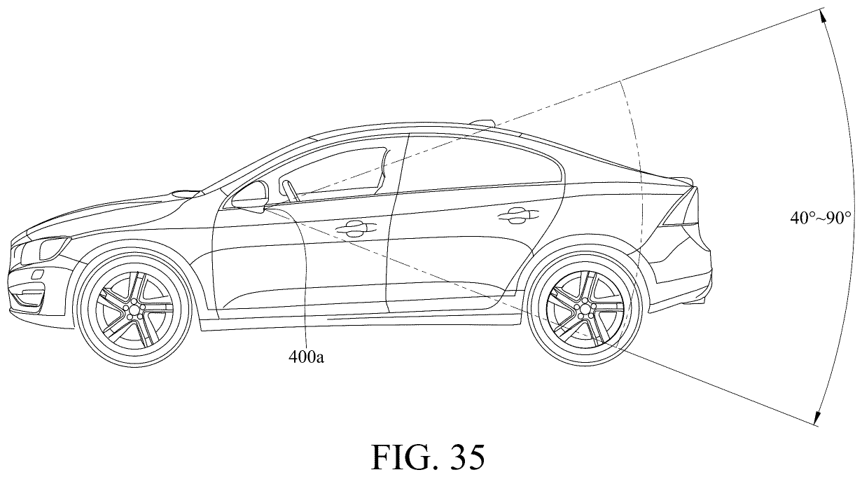

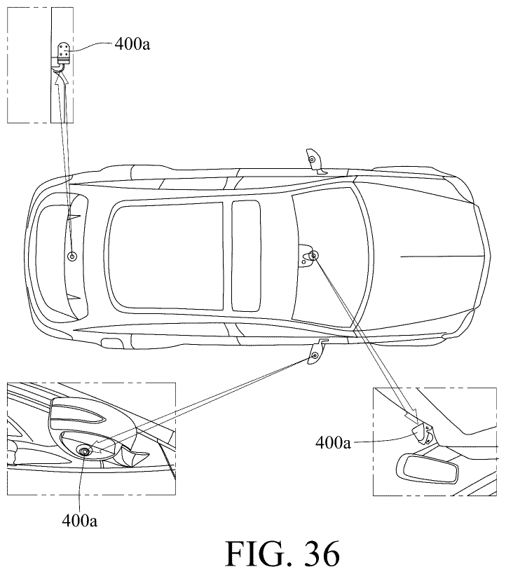

Please refer to FIG. 34 to FIG. 36. FIG. 34 is a perspective view of an electronic device according to the 8th embodiment of the present disclosure, FIG. 35 is a side view of the electronic device in FIG. 34, and FIG. 36 is a top view of the electronic device in FIG. 34.

In this embodiment, the electronic device 400 is an automobile. The electronic device 400 includes a plurality of automotive image capturing units 400a, and the image capturing units 400a each include the imaging lenses 1-4 as disclosed in the 1st to 4th embodiments of the present disclosure. The image capturing units 400a can serve as, for example, panoramic view car cameras, dashboard cameras and vehicle backup cameras.

As shown in FIG. 34, the image capturing units 400a are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 35, the image capturing units 400a are, for example, respectively disposed on the lower portion of the side mirrors. A maximum field of view of the image capturing units 400a can be 40 degrees to 90 degrees for capturing images in regions on left and right lanes.

As shown in FIG. 36, the image capturing units 400a can also be, for example, respectively disposed on the lower portion of the side mirrors and inside the front and rear windshields for providing external information to the driver, and also providing more viewing angles so as to reduce blind spots, thereby improving driving safety.

The unmanned aerial vehicle, smartphones, panoramic view car cameras, dashboard cameras and vehicle backup cameras in the embodiments are only exemplary for showing the image capturing unit of the present disclosure installed in an electronic device, and the present disclosure is not limited thereto. The image capturing unit can be optionally applied to optical systems with a movable focus. Furthermore, the image capturing unit features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens comprising:
a plurality of lens elements arranged along an optical axis, wherein the plurality of lens elements comprise a first lens element as being one of the plurality of lens elements closest to an object side of the imaging lens;
a lens barrel comprising:
a tube portion surrounding the optical axis, wherein the plurality of lens elements are disposed in the tube portion; and
an opening portion extending along a direction from the tube portion towards the optical axis, wherein the opening portion has a barrel opening and a first step surface, and the barrel opening is located on an object side of the first lens element;
a first opening element disposed between the first lens element and the opening portion to space the first lens element apart from the opening portion, wherein the first opening element and the first step surface form a gap therebetween, and the first opening element has a first light-passable opening disposed corresponding to the barrel opening; and
a second opening element disposed in the gap, wherein the second opening element has a second light-passable opening disposed opposite to the first light-passable opening.

2. The imaging lens according to claim 1,
wherein the opening portion further has a second step surface at least partially overlapped with the first lens element in a direction parallel to the optical axis;
wherein the first opening element further has a third step surface in physical contact with the second step surface of the opening portion.

3. The imaging lens according to claim 2, wherein the second step surface is located further away from the optical axis than the first step surface;
wherein the opening portion further has a first connection surface connecting the first step surface to the second step surface;
wherein the first opening element further has a second connection surface extending along a direction from a side of the third step surface close to the optical axis towards the first step surface;
wherein the first connection surface is disposed spaced apart from the second connection surface, and the opening portion and the first opening element contact the second opening element respectively through the first connection surface and the second connection surface.

4. The imaging lens according to claim 3, wherein the first opening element further has a fourth step surface extending along a direction from a side of the second connection surface close to the first step surface towards the optical axis, and the fourth step surface and the first step surface form the gap therebetween.

5. The imaging lens according to claim 2, wherein a minimum width of the gap between the first step surface and the first opening element in a direction parallel to the optical axis is G, a shortest distance in a direction parallel to the optical axis between the first step surface and the second step surface is D12, and the following condition is satisfied:
0.06≤G/D12≤0.5.

6. The imaging lens according to claim 2, wherein a minimum thickness of the opening portion at the first step surface in a direction parallel to the optical axis is less than a minimum thickness of the opening portion at the second step surface in a direction parallel to the optical axis.

7. The imaging lens according to claim 1, wherein the second opening element is a light-blocking sheet;
wherein a minimum width of the gap between the first step surface and the first opening element in a direction parallel to the optical axis is G, a thickness of the light-blocking sheet is T, and the following condition is satisfied:
1.03≤G/T≤1.97.

8. The imaging lens according to claim 1, wherein the opening portion further has a first conical surface inclined away from the optical axis along a direction from the barrel opening towards the second opening element, the first conical surface comprises an anti-reflection structure surrounding the optical axis, and the anti-reflection structure comprises a plurality of protrusions.

9. The imaging lens according to claim 1, wherein the first opening element further has a second conical surface inclined away from the optical axis along a direction from the first light-passable opening towards the second opening element, the second conical surface comprises an anti-reflection structure surrounding the optical axis, and the anti-reflection structure comprises a plurality of protrusions.

10. The imaging lens according to claim 1, wherein each of the barrel opening, the first light-passable opening and the second light-passable opening has a maximum opening diameter;
wherein the maximum opening diameter of the barrel opening is Dib, the maximum opening diameter of the first light-passable opening is Di1, the maximum opening diameter of the second light-passable opening is Di2, and the following conditions are satisfied:
0.85≤Dib/Di2≤1.15; and
0.85≤Di1/Di2≤1.15.

11. The imaging lens according to claim 1, wherein a minimum thickness of the opening portion at the first step surface in a direction parallel to the optical axis is T1, a thickness of the first opening element in a direction parallel to the optical axis is TS1, and the following condition is satisfied:
0.14≤T1/TS1≤0.92.

12. The imaging lens according to claim 1, wherein a shortest distance between the first lens element and the first light-passable opening is less than a shortest distance between the second opening element and the first light-passable opening.

13. The imaging lens according to claim 1, wherein a shortest distance between the first lens element and the first light-passable opening is less than a shortest distance between the first lens element and the second light-passable opening.

14. An imaging lens comprising:
a plurality of lens elements arranged along an optical axis, wherein the plurality of lens elements comprise a first lens element;
a lens barrel comprising:
a tube portion surrounding the optical axis, wherein the plurality of lens elements are disposed in the tube portion; and
an opening portion extending along a direction from the tube portion towards the optical axis, wherein the opening portion has a barrel opening and a first step surface;
a first opening element, wherein the first lens element abuts on a side of the first opening element away from the opening portion, the first opening element and the first step surface form a gap therebetween, and the first opening element has a first light-passable opening disposed corresponding to the barrel opening; and
a second opening element disposed in the gap, wherein the second opening element has a second light-passable opening disposed opposite to the first light-passable opening.

15. The imaging lens according to claim 14, wherein the opening portion further has a second step surface located further away from the barrel opening than the first step surface;
wherein the first opening element further has a third step surface in physical contact with the second step surface of the opening portion;
wherein a minimum width of the gap between the first step surface and the first opening element in a direction parallel to the optical axis is G, a shortest distance in a direction parallel to the optical axis between the first step surface and the second step surface is D12, and the following condition is satisfied:
0.06≤G/D12≤0.5.

16. The imaging lens according to claim 15, wherein the second step surface is located further away from the optical axis than the first step surface;
wherein the opening portion further has a first connection surface connecting the first step surface to the second step surface;
wherein the first opening element further has a second connection surface extending along a direction from a side of the third step surface close to the optical axis towards the first step surface;
wherein the first connection surface is disposed spaced apart from the second connection surface, and the opening portion and the first opening element contact the second opening element respectively through the first connection surface and the second connection surface.

17. The imaging lens according to claim 14, wherein the second opening element is a light-blocking sheet;
wherein a minimum width of the gap between the first step surface and the first opening element in a direction parallel to the optical axis is G, a thickness of the light-blocking sheet is T, and the following condition is satisfied:
1.03≤G/T≤1.97.

18. The imaging lens according to claim 14,
wherein the opening portion further has a first conical surface inclined away from the optical axis along a direction from the barrel opening towards the second opening element;
wherein the first opening element further has a second conical surface inclined away from the optical axis along a direction from the first light-passable opening towards the second opening element;
wherein at least one of the first conical surface and the second conical surface comprises an anti-reflection structure surrounding the optical axis, and the anti-reflection structure comprises a plurality of protrusions.

19. The imaging lens according to claim 14, wherein each of the barrel opening, the first light-passable opening and the second light-passable opening has a maximum opening diameter;
wherein the maximum opening diameter of the barrel opening is Dib, the maximum opening diameter of the first light-passable opening is Di1, the maximum opening diameter of the second light-passable opening is Di2, and the following conditions are satisfied:
0.8≤Dib/Di2≤1.2; and
0.8≤Di1/Di2≤1.2.

20. The imaging lens according to claim 14, wherein a minimum thickness of the opening portion at the first step surface in a direction parallel to the optical axis is T1, a thickness of the first opening element in a direction parallel to the optical axis is TS1, and the following condition is satisfied:
0.14≤T1/TS1≤0.92.

21. The imaging lens according to claim 14, wherein a shortest distance between the first lens element and the first light-passable opening is less than a shortest distance between the second opening element and the first light-passable opening.

22. An imaging lens comprising:
a plurality of lens elements arranged along an optical axis, wherein the plurality of lens elements comprises a first lens element;
a lens barrel comprising:
a tube portion surrounding the optical axis, wherein the plurality of lens elements are disposed in the tube portion; and
a barrel opening element fixed on the tube portion, wherein the barrel opening element has an opening portion extending along a direction towards the optical axis, and the opening portion has a barrel opening and a first step surface;
a first opening element, wherein the first lens element abuts on a side of the first opening element away from the opening portion, the first opening element and the first step surface form a gap therebetween, and the first opening element has a first light-passable opening disposed corresponding to the barrel opening; and
a second opening element disposed in the gap, wherein the second opening element has a second light-passable opening disposed opposite to the first light-passable opening.

23. The imaging lens according to claim 22, wherein the opening portion further has a second step surface located further away from the barrel opening than the first step surface;
wherein the first opening element is in physical contact with the second step surface of the opening portion;
wherein a minimum width of the gap between the first step surface and the first opening element in a direction parallel to the optical axis is G, a shortest distance in a direction parallel to the optical axis between the first step surface and the second step surface is D12, and the following condition is satisfied:
0.06≤G/D12≤0.5.

24. The imaging lens according to claim 22, wherein the second opening element is a light-blocking sheet;
wherein a minimum width of the gap between the first step surface and the first opening element in a direction parallel to the optical axis is G, a thickness of the light-blocking sheet is T, and the following condition is satisfied:
1.03≤G/T≤1.97.

25. The imaging lens according to claim 22,
wherein the opening portion further has a first conical surface inclined away from the optical axis along a direction from the barrel opening towards the second opening element;
wherein the first opening element further has a second conical surface inclined away from the optical axis along a direction from the first light-passable opening towards the second opening element;
wherein at least one of the first conical surface and the second conical surface comprises an anti-reflection structure surrounding the optical axis, and the anti-reflection structure comprises a plurality of protrusions.

26. The imaging lens according to claim 22, wherein each of the barrel opening, the first light-passable opening and the second light-passable opening has a maximum opening diameter;
wherein the maximum opening diameter of the barrel opening is Dib, the maximum opening diameter of the first light-passable opening is Di1, the maximum opening diameter of the second light-passable opening is Di2, and the following conditions are satisfied:
0.8≤Dib/Di2≤1.2; and
0.8≤Di1/Di2≤1.2.

27. The imaging lens according to claim 22, wherein a minimum thickness of the opening portion at the first step surface in a direction parallel to the optical axis is T1, a thickness of the first opening element in a direction parallel to the optical axis is TS1, and the following condition is satisfied:
0.14≤T1/TS1≤0.92.

28. The imaging lens according to claim 22, wherein a shortest distance between the first lens element and the first light-passable opening is less than a shortest distance between the second opening element and the first light-passable opening.

29. An image capturing unit, comprising:
the imaging lens of claim 1.

30. An electronic device, comprising:
the image capturing unit of claim 29.

31. An image capturing unit, comprising:
the imaging lens of claim 14.

32. An electronic device, comprising:
the image capturing unit of claim 31.

33. An image capturing unit, comprising:
the imaging lens of claim 22.

34. An electronic device, comprising:
the image capturing unit of claim 33.
